(19) United States
(12) Patent Application Publication
(10) Pub. No.: US 2019/0213617 A1
(43) Pub. Date: Jul. 11, 2019

(54) System and Method for Visitor Flow Analysis

(71) Applicant: Hitachi, Ltd., Chiyoda-ku,Tokyo (JP)

(72) Inventors: Su Hnin Wut YI, Singapore (SG); Wujuan LIN, Singapore (SG); Yoko KOBAYASHI, Singapore (SG)

(21) Appl. No.: 16/328,796

(22) PCT Filed: Apr. 7, 2017
(86) PCT No.: PCT/SG2017/050201

§ 371 Date: Feb. 27, 2019

(51) Int. Cl. G06Q 30/02; H04W 4/021; H04W 4/029; H04N 7/18

(52) U.S. Cl. CPC G06Q 30/0205; H04N 7/18; H04W 4/029; H04W 4/021

(57) ABSTRACT

According to various embodiments, there is provided a system for visitor flow analysis at a plurality of sites within a predetermined area. The system includes a difference estimator configured to determine a difference information between video data of visitors at at least one first site of the plurality of sites and wireless data of detected wireless devices carried by the visitors at the at least one first site; and a visitor volume distribution estimator configured to determine a visitor volume at a second site of the plurality of sites based on wireless data of detected wireless devices at the second site and the difference information at the at least one first site.

### TECHNICAL FIELD

The present invention relates to systems and methods for visitor flow analysis.

### BACKGROUND

While there are amusement parks and island resorts around the world, the number of overall visitors is certainly growing. In island resorts (e.g., Sentosa Island) that are large and separated into distant areas, visitors have to take internal public transportation to transfer from one area to another. Internal transportation usually includes several different modes of transports such as monorails, shuttle buses and trams, which are typically complimentary service for visitors to transfer within the island resort. Besides, visitor arrivals are also increasing over time as there are new attractions development, marketing and sales to promote the business. Due to strong growth of visitors' volume, visitors may need to spend a lot of time waiting for internal multi-modal transportations in order to go to different attractions, places and facilities. Therefore, one of the significant challenges has been ensuring comfortable and enjoyable multi-modal transportation service so as to obtain sustainable visitor growth for island resorts and amusement parks.

The fundamental approach to optimize internal multi-modal transportation is to understand how the visitors transfer from one place to another and also to understand how many of visitors enter and exit the island resort. One of the conventional ways to analyze visitor flow pattern is using tap-in and tap-out farecard data. It will be able to visualize origin and destination of visitors or passengers along the transportation. However, this conventional approach will not be able to apply for complimentary multi-modal transportation due to lack of tap-in/tap-out information, in which case visitors are free to use any modes of transports without tapping.

Moreover, many other systems have been developed for analyzing visitor flow and visitation patterns such as video tracking system and mobile device tracking system. However, the range of video tracking system is limited by viewpoints of cameras, and large areas may not be able to be covered by cameras in practice. Further, the range of wireless mobile device tracking may also prevent detection if the wireless connection of mobile devices is switched off, and also for those visitors who do not bring along mobile devices (e.g. elders and children). Therefore, it is essential to analyze visitor flow patterns with the ability to detect beyond sensor coverage limitations in order to prevent inaccurate results as much as possible.

### SUMMARY

According to various embodiments, there may be provided a system for visitor flow analysis at a plurality of sites within a predetermined area. The system includes a difference estimator configured to determine a difference information between video data of visitors at at least one first site of the plurality of sites and wireless data of detected wireless devices carried by the visitors at the at least one first site; and a visitor volume distribution estimator configured to determine a visitor volume at a second site of the plurality of sites based on wireless data of detected wireless devices at the second site and the difference information at the at least one first site.

According to various embodiments, there may be provided a method for visitor flow analysis at a plurality of sites within a predetermined area. The method includes determining a difference information between video data of visitors at at least one first site of the plurality of sites and wireless data of detected wireless devices carried by the visitors at the at least one first site; and determining a visitor volume at a second site of the plurality of sites, based on wireless data of detected wireless devices at the second site and the difference information at the at least one first site.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a conceptual diagram of a visitor flow analysis system according to various embodiments.

FIG. 2 shows a flow diagram showing a method for visitor flow analysis according to various embodiments.

FIG. 3 shows a diagram of a predetermined area according to various embodiments

FIG. 4 shows system architecture of a visitor flow analysis system according to various embodiments.

FIG. 5 shows exemplary components of a data processing server according to various embodiments.

FIG. 6 illustrates exemplary components of a data storage server according to various embodiments.

FIG. 7 illustrates exemplary components of clients according to various embodiments.

FIG. 8 illustrates an exemplary process flow of executing a visitor statistics register according to various embodiments,

FIG. 9 illustrates an exemplary data structure of the visitor statistics table according to various embodiments.

FIG. 10 illustrates an exemplary process flow of executing a visitor origin-destination (OD) mapper according to various embodiments.

FIG. 11 illustrates an exemplary data structure of the visitor OD information table according to various embodiments.

FIG. 12 illustrates exemplary functional modules of a visitor volume distribution computation module according to various embodiments.

FIG. 13 illustrates an exemplary process flow of computing visitor distribution at the first sites according to various embodiments.

FIG. 14 illustrates an exemplary process flow of computing visitor volume distribution at the second sites according to various embodiments.

FIG. 15 illustrates an exemplary data structure of a visitor distribution table generated by executing the visitor volume distribution computation module of FIG. 12.

FIG. 16 shows a diagram of visitor flow analysis according to various embodiments.

FIG. 17 shows a diagram illustrating the visitor volume determination at the second sites according to various embodiments.

FIG. 18 shows a diagram illustrating data update according to various embodiments.

FIG. 19 illustrates an exemplary system flow of visualizing visitor flow patterns in a predetermined area by a visitor flow pattern visualizer according to various embodiments.

FIG. 20 shows a system overview of a visitor flow analysis system according to various embodiments.

### DESCRIPTION

Various embodiments disclose a comprehensive analysis system and method of visitor flow patterns for a predetermined area. Various embodiments provide accurate results of visitor flow patterns by determining visitor flow distributions even without full sensor coverage. According to various embodiments, the limitation of particular sensor types is addressed by statistical analysis of different data sources.

Embodiments described below in context of the visitor flow analysis system are analogously valid for the respective method, and vice versa. Furthermore, it will be understood that the embodiments described below may be combined, for example, a part of one embodiment may be combined with a part of another embodiment.

It will be understood that any property described herein for a visitor flow analysis system may also hold for any visitor flow analysis system described herein. It will be understood that any property described herein for a specific method may also hold for any method described herein. Furthermore, it will be understood that for any visitor flow analysis system or method described herein, not necessarily all the components or steps described must be enclosed in the system or method, but only some (but not all) components or steps may be enclosed.

In this context, the visitor flow analysis system as described in this description may include a memory which is for example used in the processing carried out in the visitor flow analysis system. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MUM (Magnetoresistive Random Access Memory) or a PCRAM (Phase Change Random Access Memory).

In an embodiment, a “circuit” or a “module” may be understood as any kind of a logic implementing entity, which may be special purpose circuitry or a processor executing software stored in a memory, firmware, or any combination thereof. Thus, in an embodiment, a “circuit” or a “module” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” or a “module” may also be a processor executing software, e.g. any kind of computer program, e.g. a computer program using a virtual machine code such as e.g. Java. Any other kind of implementation of the respective functions which will be described in more detail below may also be understood as a “circuit” or a “module” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In order that the invention may be readily understood and put into practical effect, particular embodiments will now be described by way of examples and not limitations, and with reference to the figures.

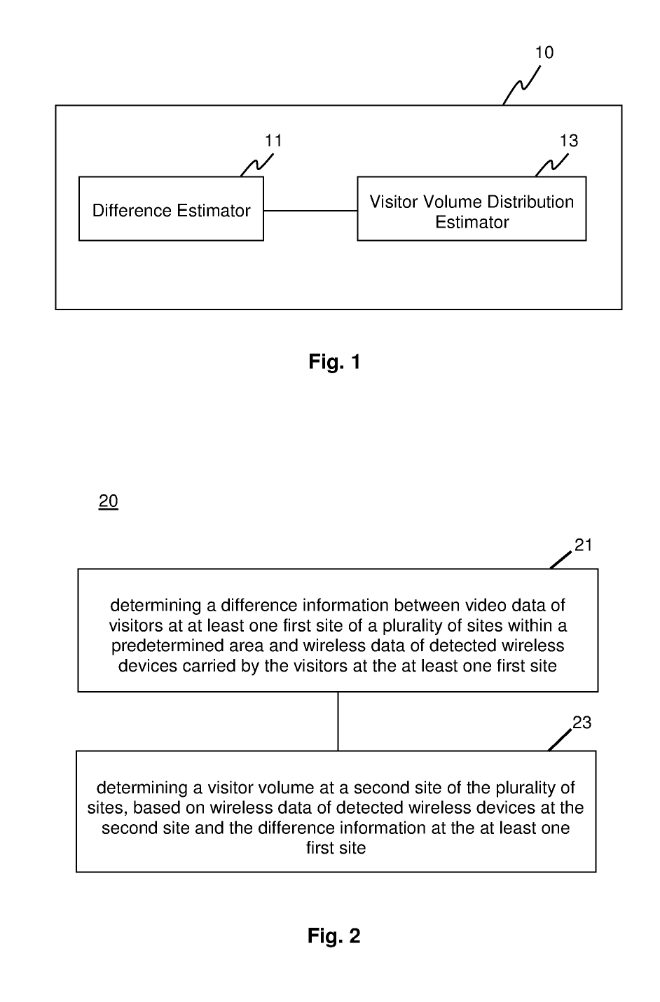

FIG. 1 shows a conceptual diagram of a visitor flow analysis system 10 according to various embodiments. The system 10 is for visitor flow analysis at a plurality of sites within a predetermined area, and may include a difference estimator 11 configured to determine a difference information between video data of visitors at at least one first site of the plurality of sites and wireless data of detected wireless devices carried by the visitors at the at least one first site. The visitor flow analysis system 10 may further include a visitor volume distribution estimator 13 configured to determine a visitor volume at a second site of the plurality of sites based on wireless data of detected wireless devices at the second site and the difference information at the at least one first site.

In other words, according to various embodiments, the visitor flow analysis system 10 may include a difference estimator 11 and a visitor volume distribution estimator 13. The difference estimator 11 is configured to determine a difference information between video data of visitors and wireless data of detected wireless devices at the at least one first site. Based on this difference information and further based on wireless data of detected wireless devices at the second site, the visitor volume distribution estimator 13 is configured to determine a visitor volume at the second site.

In various embodiments, the difference estimator 11 and the visitor volume distribution estimator 13 may each be implemented by a circuit referred to above, or may be implemented by a single circuit.

In this context, the predetermined area may include a resort (e.g. an island resort), an amusement park, a theme park, or any area with scenery, amusement, or entertainment facilities. The plurality of sites may refer to a plurality of locations or places within the predetermined area, such as an attraction, a train station (e.g. a mono-rail train station), a bus stop, or a restaurant. The at least one first site may refer to the locations or places where video data and wireless data are available, e.g. captured by a camera and a wireless device detector provided at the at least one first site. The second site may refer to the locations or places where wireless data is available, whereas video data is not available. The plurality of sites may include one or more second sites.

According to various embodiments, the at least one first site may include a train station. The difference estimator 11 is configured to determine a train arrival time based on train signaling data, and configured to determine the difference information corresponding to the train arrival time.

According to various embodiments, the difference information at the at least one first site may include at least one of: a volume of undetected wireless devices at the at least one first site, representing a difference between a volume of detected visitors and a volume of detected wireless devices at the at least one first site; a ratio between the volume of undetected wireless devices and the volume of detected wireless devices at the at least one first site; a ratio between the volume of undetected wireless devices and the volume of detected visitors at the at least one first site; or a ratio between the volume of detected wireless devices and the volume of detected visitors at the at least one first site.

According to various embodiments, the wireless data of detected wireless devices at the at least one first site or at the second site may include at least one of: an identification code of each detected wireless device; or a previous site where each wireless device is detected, wherein the previous site is associated with the identification code of the respective wireless device.

In various embodiments, the identification code may be unique to each wireless device, such that different wireless devices have different identification codes. The identifier code may be a media access control (MAC) identification document (ID), also referred herein as MAC address or MAC-ID. The identifier code may also be any one of a unique device identifier (UDID), Android ID, international mobile equipment identity (IMEI) or international mobile subscriber identity (IMSI).

According to various embodiments, the visitor volume distribution estimator 13 is further configured to determine a weighted value of detected wireless devices at the second site based on the wireless data of detected wireless devices at the second site. The weighted value of detected wireless devices at the second site may include at least one of a volume of wireless devices previously detected at each of the at least one first site and presently detected at the second site, or a percentage of wireless devices previously detected at each of the at least one first site which are presently detected at the second site.

In various embodiments, the visitor volume distribution estimator 13 is configured to determine the visitor volume at the second site based on the weighted value of detected wireless devices at the second site and the difference information at the at least one first site.

According to various embodiments, the visitor volume distribution estimator 13 is further configured to determine a visitor volume at the at least one first site based on the video data of visitors at the at least one first site.

According to various embodiments, the visitor volume distribution estimator 13 is further configured to generate a visitor distribution table for the wireless devices detected at the at least one first site and the second site. The visitor distribution table may include at least one of: previous sites and current sites where the wireless devices are detected, wherein the previous sites and the current sites are associated with respective identification codes of the respective wireless devices; or the difference information at the at least one first site where the wireless devices are detected, wherein the difference information is associated with the respective identification codes of the respective wireless devices.

According to various embodiments, the system 10 may further include a camera at each of the at least one first site, and a wireless device detector at each of the at least one first site and at the second site. The camera is configured to provide the video data of visitors at each of the at least one first site; and the wireless device detector is configured to provide the wireless data of detected wireless devices at each of the at least one first site and the wireless data of detected wireless devices at the second site, respectively.

In various embodiments, the camera may be a video camera, e.g. a closed-circuit television (CCTV), configured to collect the video data (e.g. CCTV data) of visitors at each of the first site. Based on the video data, the volume of visitors captured in the video data may be determined.

According to various embodiments, a visitor may carry a wireless device, such as a mobile telephone, a mobile computer, a tablet computer, a gaming console, a digital camera, a digital audio player, a smart watch or a wearable technology device. While the wireless connection of the wireless device is activated, it may be detectable by the wireless device detector. The wireless device detector may include one of wireless receivers, wireless transceivers or wireless routers, configured to provide wireless internet access in a wireless local area network, for example. The wireless device detector may collect wireless data of the detected wireless devices, including identification codes of the respective wireless devices. Accordingly, the volume of detected wireless devices may be determined from the wireless data.

According to various embodiments, the system 10 may further include a visitor statistics register (not shown) configured to determine a volume of visitors entering the predetermined area based on at least one of video data or entry ticket data at an entrance of the predetermined area. The visitor statistics register is further configured to determine a volume of visitors exiting the predetermined area based on wireless data of detected wireless devices at an exit of the predetermined area. In various embodiments, the visitor statistics register is further configured to generate a visitor statistics table including a total volume of visitors within the predetermined area at respective time.

According to various embodiments, the system 10 may further include a visitor origin-destination mapper (not shown) configured to determine a trajectory of each visitor based on historical wireless data of wireless devices detected at the at least one first site and the second site.

In various embodiments, the visitor origin-destination mapper is further configured to generate an origin-destination information table. The origin-destination information table includes the trajectory of the respective visitor, including an identification code of the respective wireless device carried by the respective visitor, an origin of the respective visitor, and a destination of the respective visitor.

According to various embodiments, the system 10 may further include a visitor flow pattern visualizer (not shown) configured to generate a graphic visualization of visitor flow patterns. The visitor flow patterns are determined based on at least one of the determined visitor volume, a visitor distribution table for the wireless devices detected at the at least one first site and the second site, a visitor statistics table comprising a total volume of visitors within the predetermined area at respective time, or an origin-destination information table comprising trajectories of visitors.

FIG. 2 shows a flow diagram 20 showing a method for visitor flow analysis according to various embodiments. The flow diagram 20 includes a plurality of processes 21 and 23. In 21, a difference information between video data of visitors at at least one first site of a plurality of sites within a predetermined area and wireless data of detected wireless devices carried by the visitors at the at least one first site may be determined. In 23, a visitor volume at a second site of the plurality of sites may be determined, based on wireless data of detected wireless devices at the second site and the difference information at the at least one first site.

Various embodiments of the visitor flow analysis system and method are described in more detail below.

The system and method according to various embodiments provide an effective approach to compute the volume/number of visitors within a predetermined area, e.g., an island resort which is typically a distant area. Thus, various embodiments correlate and analyze multiple sensor data (e.g., video data, wireless data, etc.) in order to detect visitors' volume distributions without full coverage of sensors, and detect congested area and track visitors who are moving around island resorts using multi-modal transport modes. Specifically, various embodiments provide comprehensive analysis to compute the number/volume of undetected visitors due to limitation of particular sensor coverage, e.g. undetected visitors due to lack of a camera at a particular site.

During visiting such a large area, visitors may need to take internal public transportation to transfer from one area to another. Therefore, the visualization of visitors flow patterns will assist operators or companies who are in charge of development of the island resort to optimize multi-modal transportation, and hence sustaining visitors' growth over time. According to various embodiments, the system and method may further provide visitors' trajectories from start to end within the island resort, including transport modes as well as duration of stay across the island resort.

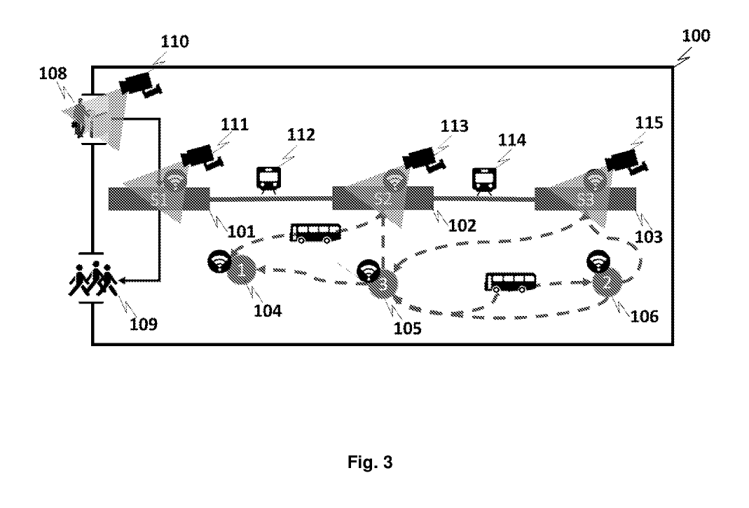

FIG. 3 shows a diagram of a predetermined area 100 according to various embodiments, in which the system and method of various embodiments may be implemented. In this exemplary embodiment, the predetermined area may be an island resort having multi-modal transport modes and wireless data availability. The island resort may be a large and distant area, and provides service for internal transfer to visit different sites within the island resort. The internal transportation may include multi-modal modes of transports, such as monorails, shuttle buses and trams, which may be complimentary services for visitors to transfer between different sites 104, 105, 106 within the island resort 100.

The island resort 100 includes a plurality of sites, such as train stations S1, S2 and S3, and attractions 104, 105 and 106. In this exemplary embodiment, video data (e.g. CCTV data) and wireless data (e.g. wireless local area network data) at the train stations 102, 102, 103 (S1-S3) are available, e.g. from the cameras 111, 113, 115 and wireless device detectors provided at these stations, and these train stations 102, 102, 103 may be each referred to as the first site of the plurality of sites as described above. Wireless data at the attractions 104, 105, 106 is available, and these attractions may be each referred to as the second site of the plurality of sites.

As shown in the embodiments of FIG. 3, visitors may need to use entry tickets 108, e.g. fare cards, to enter the island resort 100, and visitors leave the island resort at the exit 109 without tapping. CCTV 110 may also be provided at the entrance. Wireless network service may also be provided at the exit 109, for example, to detect the number of wireless devices exiting the resort 100. Wireless network service and CCTV 111, 113, 115 are provided at mono-rail stations 101, 102, 103, and may be co-located for each station. Wireless network service may also be provided at key locations and open areas, such as the attractions 104, 105, 106. Train signaling data 112, 114 may also be provided or retrieved, from which train arrival and departure times for each station may be determined.

Based on one or more of the video data, wireless data, entry ticket data, and train signaling data, the system and method are able to analyze visitor flow in various sites of the island resort 100 according to various embodiments.

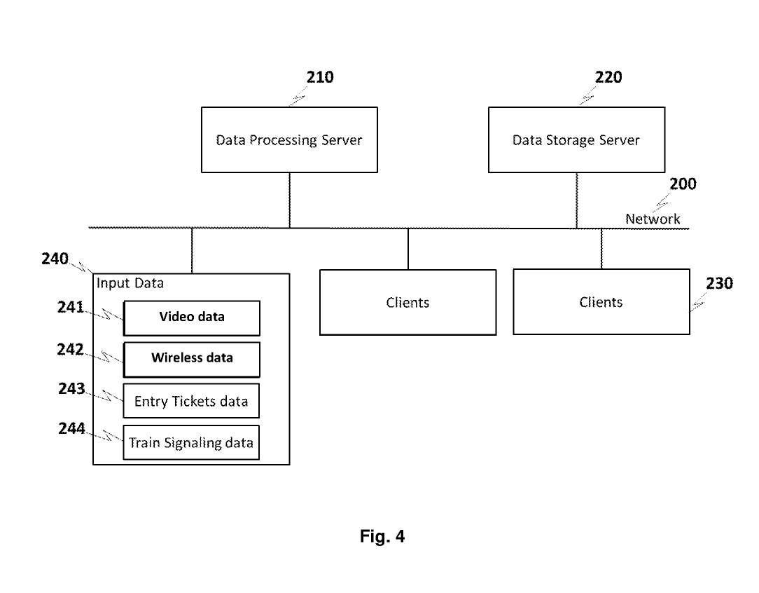

FIG. 4 shows system architecture of a visitor flow analysis system according to various embodiments. The system architecture of FIG. 4 may be applied for the visitor flow analysis system and method described in various embodiments above.

The system may include a data processing server 210, a data storage server 220 and a plurality of clients 230, which are connected to a network 200 and may communicate with each other via local or global network connections. The data processing server 210 is configured to perform data analysis. The data storage server 220 may be utilized to store input data which may be collected over a period of time. The clients 230 are devices, such as display system or interactive dashboard, which can interface with user for data analysis. Input data 240 includes multiple data sources, such as video data 241, wireless data 242, entry tickets data 243 and train signaling data 244. The video data 241 may be CCTV data 110, 111, 113, 115 captured at the first sites 101, 102, 103 and at the entrance in the predetermined area 100 of FIG. 3. The wireless data 242 may be wireless local area network (WLAN) data, for example, detected at the first sites 101, 102, 103 and the second sites 104, 105, 106 in the predetermined area 100 of FIG. 3. The entry tickets data 243 may be the entry ticket data 108 collected at the entrance of FIG. 3. The train signaling data 244 may be the train signaling data 112, 114 in FIG. 3. The input data 240 may be stored in the data storage server 220, and may be retrieved by the data processing server 210 for data analysis.

In an exemplary embodiment, the data processing server 210 is configured to determine the difference information and determine the visitor volume distribution, and accordingly the data processing server 210 may include the difference estimator 11 and the visitor volume distribution estimator 13 described above.

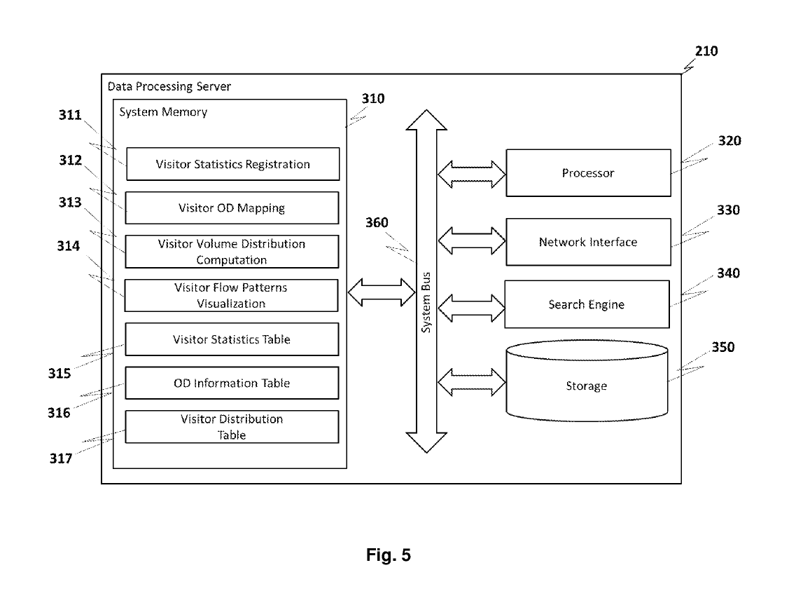

FIG. 5 shows exemplary components of a data processing server 210 according to various embodiments. The data processing server 210 may include a system memory 310, a processor 320, a network interface 330, a search engine 340 and a storage 350.

The data processing server 210 may further include a system bus 360 which is coupled to each of the system memory 310, the processor 320, the network interface 330, the search engine 340 and the storage 350. The system bus 360 may be configured to transmit or relay electrical signals or power between the system memory 310, the processor 320, the network interface 330, the search engine 340 and the storage 350. In other words, the components of the data processing server 210 may be interconnected by the system bus 360 for transmission of commands and data.

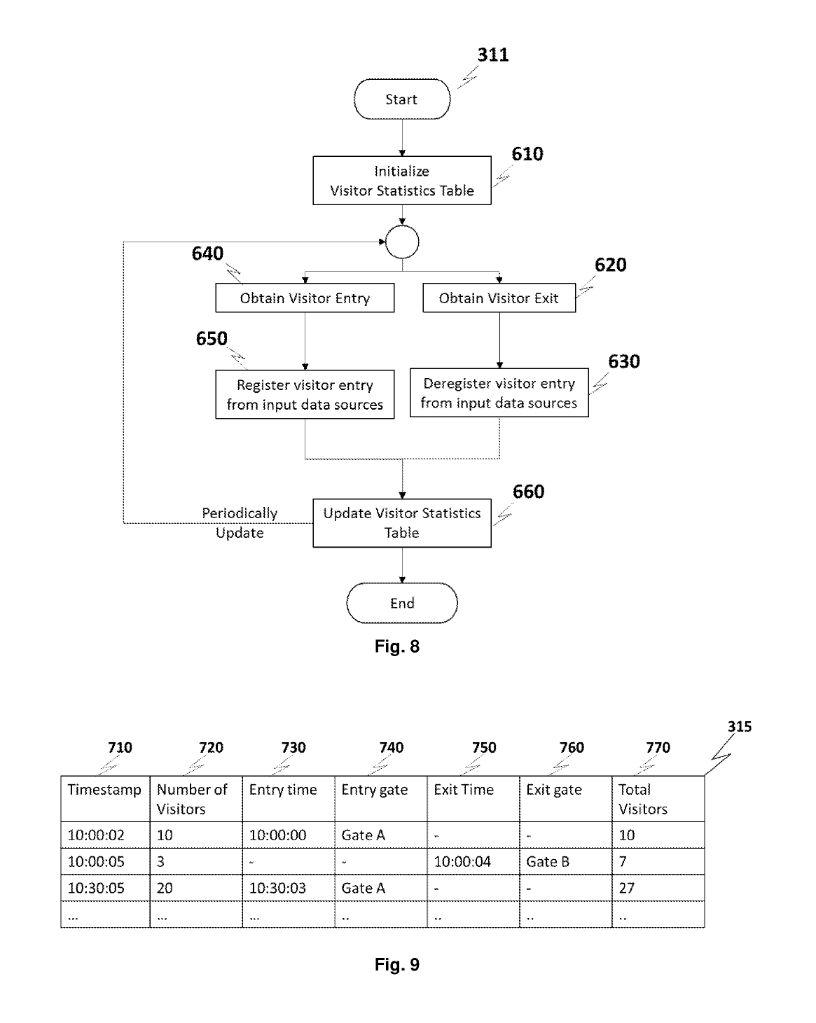

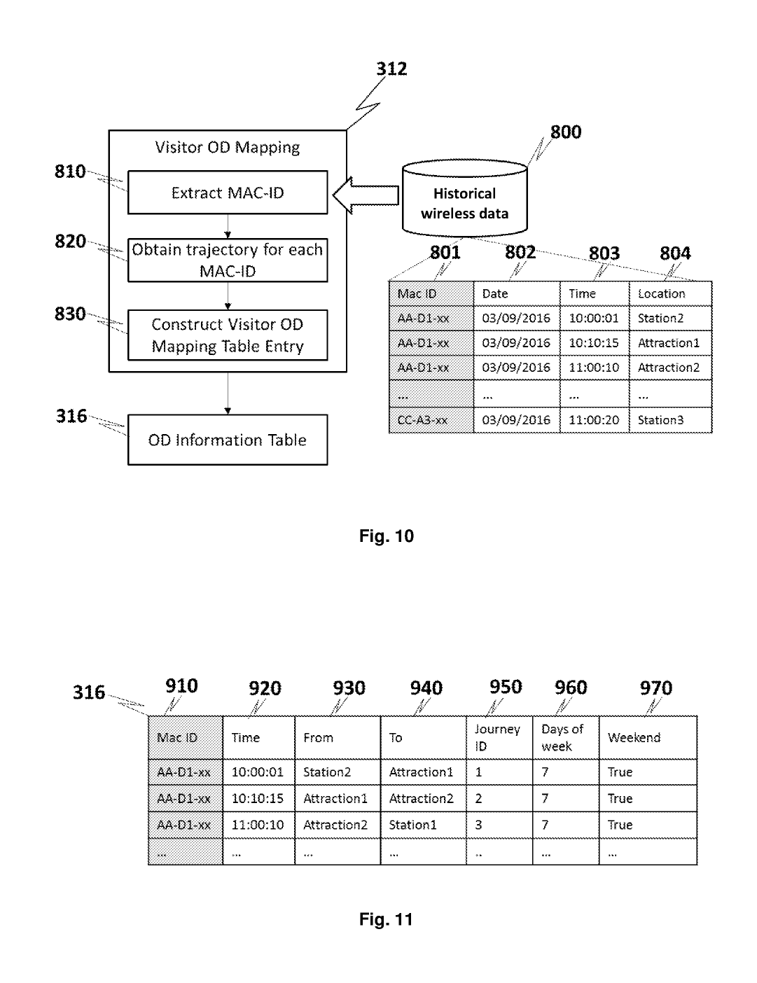

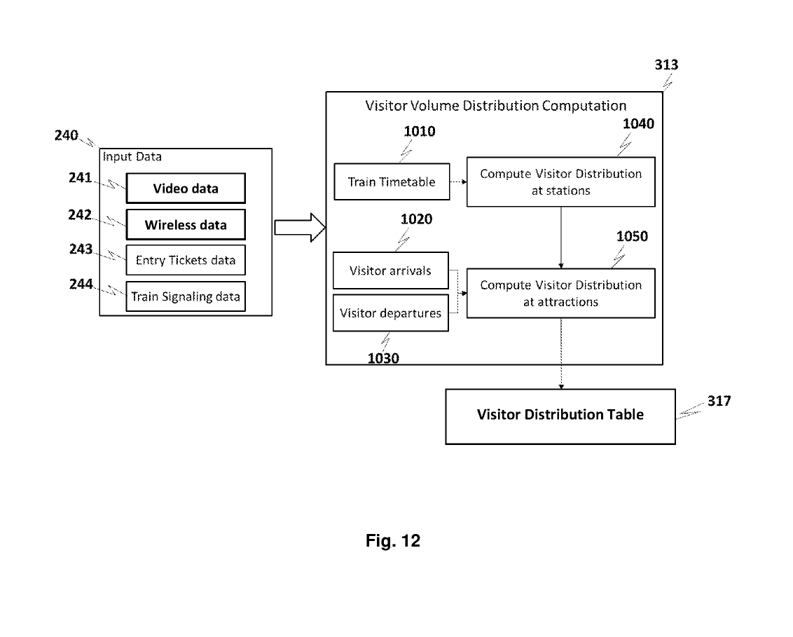

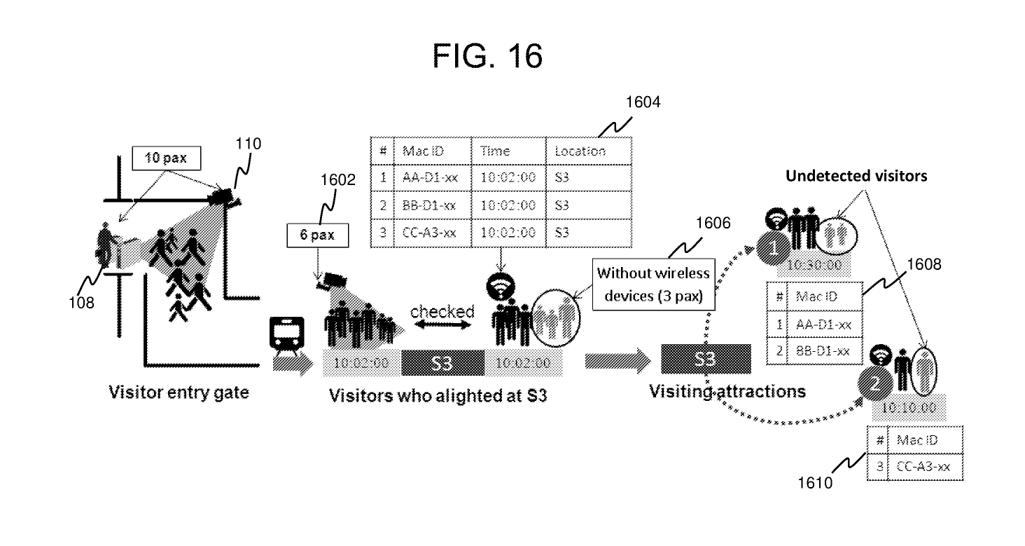

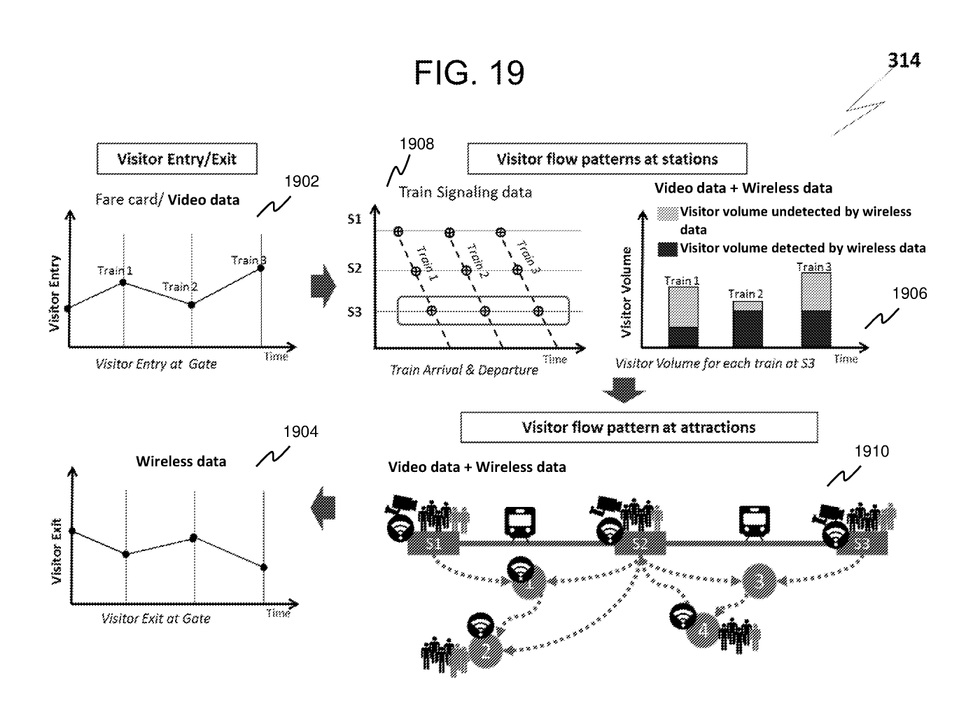

The system memory 310 may store a plurality of instructions executable by the processor 320. The plurality of instructions may also be referred herein as programs. The programs may include a visitor statistics registration module 311 (illustrated in FIG. 8 below), a visitor origin-destination OD mapping module 312 (illustrated in FIG. 10 below), a visitor volume distribution computation module 313 (illustrated in FIG. 12 below) and a visitor flow pattern visualization module 314 (illustrated in FIG. 19 below). The visitor statistics registration module 311 may be the visitor statistics register described in the system 10 of FIG. 1 above. The visitor origin-destination OD mapping module 312 may be the visitor origin-destination mapper described in the system 10 of FIG. 1 above. The visitor volume distribution computation module 313 may be the visitor volume distribution estimator 13 described in the system 10 of FIG. 1 above, and may further include the difference estimator 11 of the system 10. The visitor flow pattern visualization module 314 may be the visitor flow pattern visualizer described in the system 10 of FIG. 1 above. These programs may reside in the system memory 310. Moreover, a visitor statistics table 315 (illustrated in FIG. 9), an OD information table 316 (illustrated in FIG. 11) and a visitor distribution table 317 (illustrated in FIG. 15) may reside in the system memory 310, in order for the processor to look up data and perform further data analysis.

The storage 350 may be configured to store temporary results and output data, which may be generated by data analysis of the data processing server 210. The processor 320 may be configured to perform data analysis, for example, to run or execute one or more instances of the visitor statistics registration module 311, the visitor origin-destination OD mapping module 312, the visitor volume distribution computation module 313 and the visitor flow pattern visualization module 314. The network interface 330 may be utilized to establish connections for sending and receiving data and commands. The search engine 340 may be utilized to receive query in order to search data in the storage 350.

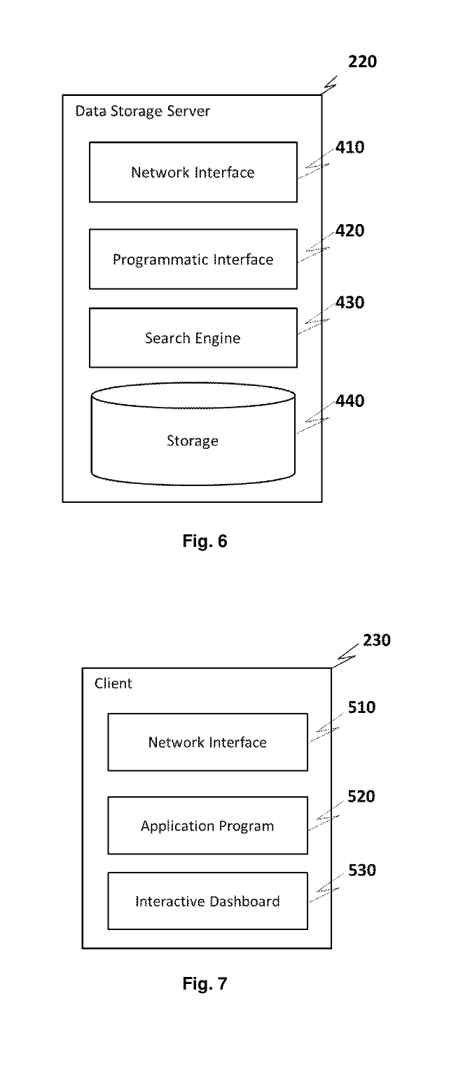

FIG. 6 illustrates exemplary components of the data storage server 220 according to various embodiments. The data storage server 220 organizes input data which may be collected over a period of time, and provides interface to access data for further data analysis. The data storage server 220 may include a network interface 410, a programmatic interface 420, a search engine 430 and a storage 440. The network interface 410 may be configured to establish the connection with other components or devices, such as the data processing server 210 and clients 230, via the network 200 (e.g. a local area network or a wide area network). The programmatic interface 420 is a set of protocols for building search query which may be used by the search engine 430. The search engine 430 will accelerate querying and retrieving data from the storage 440.

FIG. 7 illustrates exemplary components of the clients 230 according to various embodiments. A client 230 may represent a display system for visualization of data analysis and for presentation to users. In the client 230, a network interface 510, an application program 520 and an interactive dashboard 530 may reside. The network interface 510 may be provided to establish the connection with other components, such as the data processing server 210 and the data storage server 220, via the network 200. The application program 520 may generate a set of commands to set up and simulate overall picture of visitor flows as well as individual's mobility. The interactive dashboard 530 may represent a graphical user interface for data analysis, which may provide an integrated multi-level analysis approach with advanced reporting tool.

FIG. 8 illustrates an exemplary process flow of executing a visitor statistics register according to various embodiments, so as to construct a visitor statistics table 315. The visitor statistics register may be the visitor statistics registration module 311 described above. In step 610, initialization of a visitor statistics table may be performed. Then the process will proceed to obtain visitor entry at 640 and obtain visitor exit at 620 in parallel threads. At 640, the visitor statistics register 311 is configured to obtain the visitor entry data, e.g., to determine a volume of visitors entering the predetermined area 100 based on at least one of the video data 241 or the entry tickets data 243 at the entrance. At 620, the visitor statistics register 311 is configured to obtain the visitor exit data, e.g., to determine a volume of visitors exiting the predetermined area 100 based on the wireless data 242, e.g. by determining the number of detected wireless devices from the wireless data 242 at the exit. Upon obtaining visitor entry counts, the process will register the number of visitors who enter the predetermined area 100 at step 650. Simultaneously, the process will deregister visitor entry at 630 upon obtaining the number of visitors exiting the predetermined area. The process may further update the visitor statistics table at 660, wherein the visitor statistics table 315 may include visitor arrivals and departures from the predetermined area 100. The process may continue periodically until no further visitor entry and exit data is found.

FIG. 9 illustrates an exemplary data structure of the visitor statistics table 315 according to various embodiments. The visitor statistics table 315 may include, but is not limited to, timestamp of system update transaction 710, aggregated number of visitors entering or exiting the predetermined area at the corresponding timestamp 720, visitor entry time 730, entry gate 740 for obtaining visitor entry at step 640 of FIG. 8. The visitor statistics table 315 may further include visitor exit time 750, visitor exit gate 760 for obtaining visitor exit at step 620 of FIG. 8. The visitor statistics table 315 may further include total number of visitors 770, which may represent the number of visitors within the predetermined area 100 at the corresponding timestamp of system update transaction 710.

FIG. 10 illustrates an exemplary process flow of executing a visitor origin-destination (OD) mapper according to various embodiments, so as to construct an OD information table 316. The visitor origin-destination mapper may be the visitor OD mapping module 312 described above. In this visitor OD mapping module 312, the historical wireless data 800 may be retrieved, which may be collected over a period of time, e.g., over a period of several weeks or months. The historical wireless data 800 may be collected at the first site 101, 102, 103 and the second site 104, 105, 106, and may included information of wireless devices detected at the first site and the second site. In an exemplary embodiment, the historical wireless data structure may include wireless device ID 801 (e.g. the identification code, e.g. Mac-ID), date 802, time 803 and location 804.

At 810, the visitor OD mapper 312 is configured to extract the identification codes, e.g. the MAC-ID, of the wireless devices based on the historical wireless data 800. Upon retrieving the MAC-ID of a wireless device, the visitor OD mapper 312 may determine a trajectory for each unique MAC-ID at 820, representing a trajectory of the visitor carrying the wireless device with the unique MAC-ID. At 830, the visitor OD mapper 312 may further construct a visitor OD information table 316, also referred to as a visitor OD mapping table, which records trajectories from start to end during the visit to the predetermined area. As the output data of the visitor OD mapper 312, the OD information table 316 is generated and output.

FIG. 11 illustrates an exemplary data structure of the visitor OD information table 316 according to various embodiments. The visitor OD information table 316 include the trajectory of the respective visitor, which may include but is not limited to, wireless device ID 910 (e.g. the identification code, e.g. Mac-ID) of the wireless device carried by the visitor, system updated time 920, an origin of the visitor (from) 930, a destination of the visitor (to) 940, journey ID 950 for linking up trajectories from start to end, days of week 950 which may be clustered for particular days, weekend 970 for indicating if the corresponding visit was made on weekend.

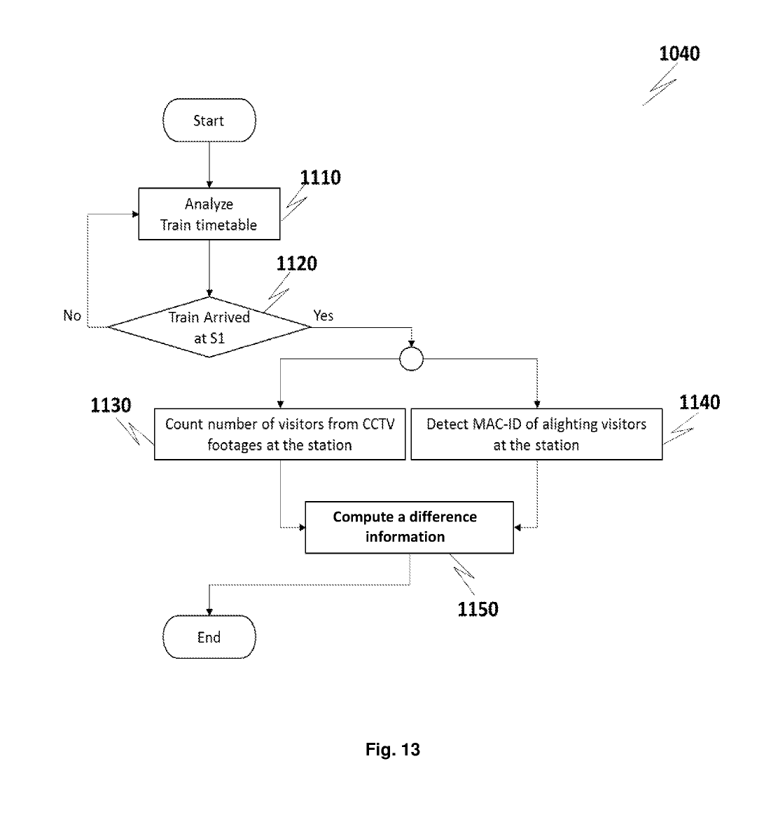

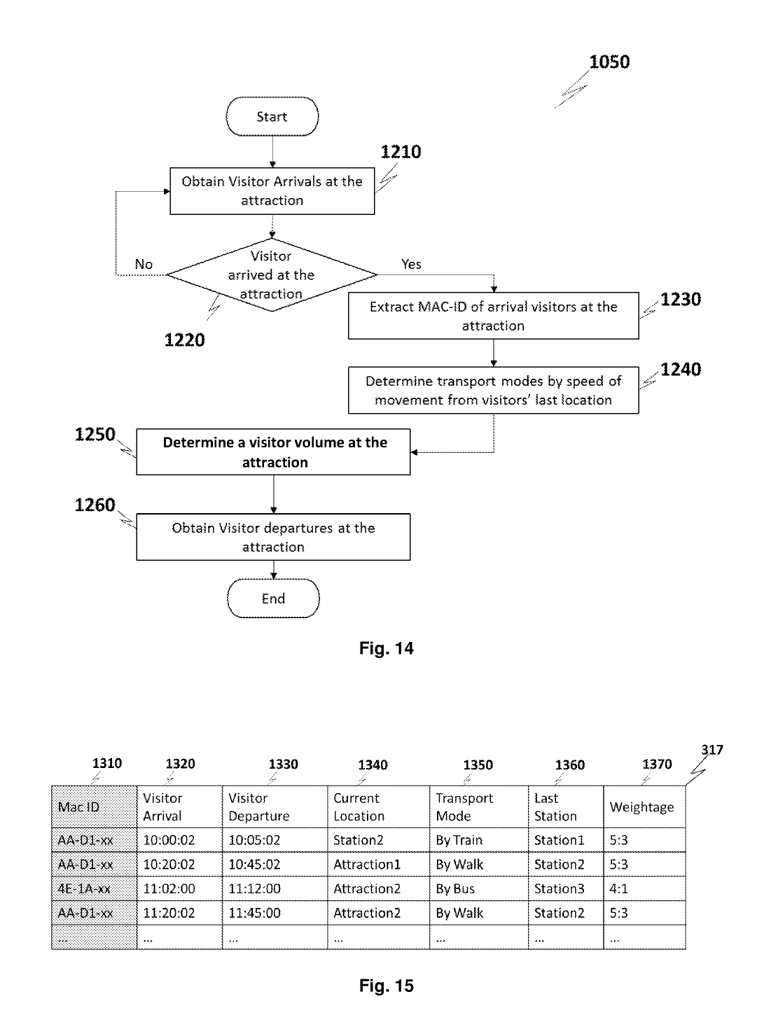

FIG. 12 illustrates exemplary functional modules of a visitor volume distribution computation module 313 according to various embodiments. The visitor volume distribution computation module 313 may be or may include the visitor volume distribution estimator 13 of FIG. 1. In the visitor volume distribution computation module 313, the process may be distributed across multiple apparatus for the first sites (e.g., for each station 101, 102, 103) and the second sites (e.g. for each attraction 104, 105, 106). The computation or determination process may be categorized into computation/determination of visitor distribution at stations 1040 (further illustrated in FIG. 13) and computation of visitor distribution at attractions 1050 (further illustrated in FIG. 14). For example, the visitor volume distribution estimator 13 of FIG. 1 may be executed at 1050 to determine the volume of visitors at the second site, i.e. the attractions in this embodiment. The difference estimator 11 of FIG. 1 may be executed in the process step 1040.

The input data 240 to the visitor volume distribution computation module 313 may include video data 241 for counting the number of alighting visitor for each station, wireless data 242 for recording visitor trajectories and detecting the number of wireless devices, entry ticket data 243, and train signaling data 244. The wireless data may include at least one of an identification code of each detected wireless device, or a previous site where each wireless device is detected wherein the previous site is associated with the identification code of the respective wireless device. The visitor volume distribution computation module 313 may construct a train timetable 1010 to analyze train arrival timing and departure timing for each station. The visitor volume distribution computation module 313 may further detect or determine visitor arrivals 1020 and visitor departures 1030 at each attraction to track visitors for each attraction. As the output of the visitor volume distribution computation module 313, the visitor distribution table 317 (further illustrated in FIG. 15) will be generated.

FIG. 13 illustrates an exemplary process flow of computing visitor distribution at the first sites (e.g. stations) according to various embodiments. In the computation of visitor distribution at the stations 1040, the process may analyze the train timetable 1010 which indicates train arrival time at step 1110. The check process 1120 may be repeated periodically for every train arrival. Once the train arrival at the station (e.g. station S1) is detected in step 1120, computation of the number of alighting visitors from the video data (e.g. CCTV footages) at 1130 and computation of the number of detected wireless devices from wireless data (e.g., by detecting Mac-ID) at 1140 are conducted simultaneously. The output result of step 1130 represents the volume of detected visitors at the station S1. The output results of both computations 1130, 1140 are proceeded to step 1150 to determine a difference information between the video data representing the volume of visitors and the wireless data representing the volume of detected wireless devices carried by the visitors.

The difference information may include at least one of: a volume of undetected wireless devices at the station S1, representing a difference between the volume of detected visitors and the volume of detected wireless devices at the station S1; a ratio between the volume of undetected wireless devices and the volume of detected wireless devices at the station S1; a ratio between the volume of undetected wireless devices and the volume of detected visitors at the station S1; or a ratio between the volume of detected wireless devices and the volume of detected visitors at the station S1.

In an illustrative example, when the train arrived at the station, there may be total 6 visitors alighting at the station. In this example, the output result of 1130 will be 6 visitors, and the output result of 1140 may be only 3 wireless devices. This may be due to limitation of wireless sensor coverage, or due to some wireless devices not activating wireless connection, or due to some visitors not carrying a wireless device. It may be determined that the volume of undetected wireless devices is 3. Therefore, the ratio between the volume of undetected wireless devices and the volume of detected wireless devices is 1:1. In other words, out of total 6 visitors who alighted at the station, only 3 visitors carry wireless devices with wireless connection, and another 3 visitors did not carry wireless devices or carry wireless devices without wireless connection. The ratio may be clustered by train arrival time for each station and then further utilized to track MAC-ID and generate weightage for the volume of undetected wireless devices in the visitor distribution table 317.

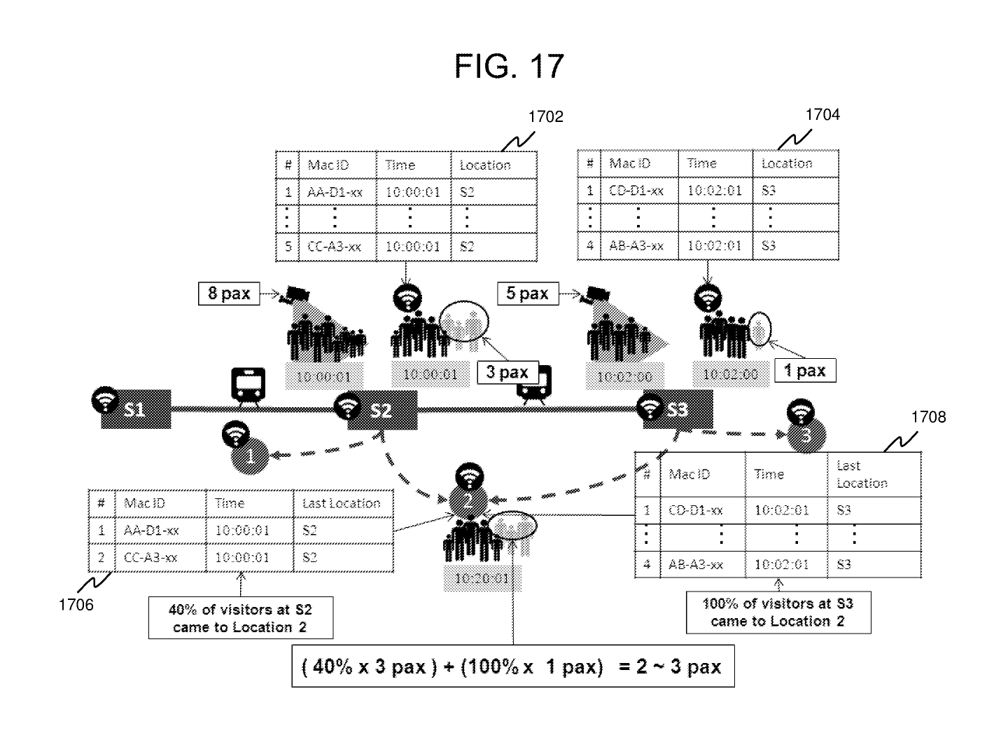

FIG. 14 illustrates an exemplary process flow of computing visitor volume distribution at the second sites (e.g. attractions) according to various embodiments. In the computation of visitor distribution at the attractions 1050, the process may obtain visitor arrivals at the attraction at 1210. The check process 1220 may be repeated periodically for every visitor arrival. Upon detecting visitor arrivals at 1220, the process may extract MAC-ID of wireless devices carried by arriving visitors at the attraction at 1230. The previous sites where the visitor is detected, i.e. the visitor last visited place, may be located from the wireless data of detected wireless devices collected at the attraction. In step 1240, the process may further determine transport modes of the visitors by identifying individual speed of visitor's movement from the last visited site to the current site, which may thus indicate which transport mode is likely taken by the visitor. In step 1250, the process will compute a total visitor volume at the attraction based on the difference information determined at 1150 above and the wireless data of detected wireless devices at the attraction. The total visitor volume at the attraction includes the visitor volume (i.e. the volume of wireless devices) detected by the wireless data at the attraction, and the estimated visitor volume undetected by the wireless data at the attraction. In other words, the difference information determined at 1150 of the last visited station may be used as a compensator to determine the estimated visitor volume undetected by the wireless data at the attraction, so as to determine the total visitor volume. In various embodiments, the determination at 1250 may further include percentage of visitors who are coming from different stations, as will be described in more detail with reference to FIGS. 16 and 17 below. In step 1260, the process may update visitor departure timing in order to analyze duration of stay at the attraction.

FIG. 15 illustrates an exemplary data structure of a visitor distribution table 317 generated by executing the visitor volume distribution computation module 313 of FIG. 12. The visitor distribution table 317 may include at least one of: previous sites and current sites where the wireless devices are detected, wherein the previous sites and the current sites are associated with respective identification codes of the respective wireless devices; or the difference information at the at least one first site where the wireless devices are detected, wherein the difference information is associated with the respective identification codes of the respective wireless devices.

In the exemplary embodiment of FIG. 15, the visitor distribution table 317 may include, but is not limited to, wireless device identification code (e.g., MAC-ID) 1310, visitor arrival or train arrival timing 1320, visitor departure time 1330, current location 1340, transport mode 1350 which is likely to be taken by the visitor to the current location, last location 1360 where the visitor is detected, and weightage 1370 which indicates for undetected volume of wireless devices in the visitor distribution. In this example, the weightage 1370 may be the ratio between the volume of undetected wireless devices and the volume of detected wireless devices at the respective station. The weightage 1370 may also be other types of difference information described above.

FIG. 16 shows a diagram of visitor flow analysis according to various embodiments. According to the system and method of various embodiments above, data from multiple types of sensors, e.g., farecard data, signaling data, video data and wireless data, may be integrated, and accordingly visitor flow at various sites can be linked, allowing to estimate undetected visitor volumes where full coverage of particular sensor type (for example, cameras) is not available.

In FIG. 16, the volume of visitors entering the entry gate may be determined from fantasized either one or both of the farecard data 108 and the video data 110. The visitors may take trains, e.g. mono-rail trains to transfer from one site to another site. In an exemplary embodiment, at a train station S3, video data 1602 of visitors and wireless data 1604 of detected wireless devices are collected and compared. From the video data 1602, it is determined that 6 visitors (6 pax) alighted at the station S3 at 10:02:00. From the wireless data 1604, it is determined that 3 wireless devices are detected at 10:02:00, representing 3 visitors carrying the wireless devices. Based on the comparison of the video data 1602 and the wireless data 1604, a difference information is determined. The difference information may be the volume of undetected wireless devices at the station S3, i.e. 3 pax in this example. The difference information may be the ratio between the volume of undetected wireless devices and the volume of detected visitors, i.e., 50%.

The visitors detected at the station S3 may proceed to other sites, e.g. attraction 1 and attraction 2. In this example, 2 wireless devices which were previously detected at the station S3 are detected at the attraction 1 from the wireless data 1608 at the attraction 1, and 1 wireless device which was previously detected at the station S3 is detected at the attraction 2 from the wireless data 1610 at the attraction 2. Based on the difference information at the previous site S3 and the number of wireless devices detected at the attraction 1, the volume of undetected visitors/wireless devices at the attraction 1 may be estimated accordingly, in this example, 2 pax. Based on the difference information at the previous site S3 and the number of wireless devices detected at the attraction 2, the volume of undetected visitors/wireless devices at the attraction 2 may be estimated accordingly, in this example, 1 pax. The estimated volume of undetected visitors or undetected wireless devices may be added to the number of detected wireless devices at each of the attractions to determine the respective visitor volume at the respective attraction, as described in more detail in FIG. 17 below.

FIG. 17 shows a diagram illustrating the visitor volume determination at the second sites according to various embodiments.

In the example of FIG. 17, the first sites are stations S2 and S3, where both video data and wireless data are available, i.e. both camera and wireless device detector are provided at the first sites. The second site is the attraction 2 where only wireless data is available, i.e. only wireless device detector is provided at the second site.

From the video data at the station S2, 8 visitors (8 pax) are detected. From the wireless data 1702 at the station S2, 5 wireless devices (5 pax) are detected. Accordingly, the difference information at the station S2 is 3 pax.

From the video data at the station S3, 5 visitors (5 pax) are detected. From the wireless data 1704 at the station S3, 4 wireless devices (4 pax) are detected. Accordingly, the difference information at the station S3 is 1 pax.

From the wireless data 1706 at the attraction 2, 2 wireless devices (2 pax) are detected. It is further determined that the previous site where these 2 devices (with the same MAC-ID AA-D1-xx and CC-A3-xx) were detected is the station S2. Based on the wireless data 1706, the visitor volume distribution estimator 13, 313 is configured to determine a weighted value of detected wireless devices at the attraction 2. The weighted value include at least one of a volume of wireless devices previously detected at each of the at least one first site and presently detected at the second site, or a percentage of wireless devices previously detected at each of the at least one first site which are presently detected at the second site. In this example, the weighted value may be the percentage of wireless devices previously detected at the station S2 which are presently detected at the attraction 2, i.e. 40%, since 40% of the 5 wireless devices previously detected at the station S2 are presently detected at the attraction 2. Based on this weighted value of 40% and the difference information of 3 pax at the station S2, the volume of undetected visitors at the attraction 2 may be estimated to be (40%×3 pax). Accordingly, the visitor volume at the second site may be determined, for example, by adding the volume of detected wireless devices (i.e. 2) and the estimated volume of undetected visitors (40%×3 pax).

In a further embodiment, the wireless data at the attraction 2 may include wireless devices from more than one station. In this illustrative example, the wireless data at the attraction 2 may include wireless data 1706 and 1708. The wireless data 1708 includes information of detected wireless devices from the station S3.

Similarly, from the wireless data 1708 at the attraction 2, 4 wireless devices (4 pax) are detected. It is further determined that the previous site where these 4 devices were detected is the station S3. Based on the wireless data 1708, the visitor volume distribution estimator 13, 313 is configured to determine a weighted value of detected wireless devices at the attraction 2. In this example, the weighted value may include the percentage of wireless devices previously detected at the station S3 which are presently detected at the attraction 2, i.e. 100%, since 100% of the 4 wireless devices previously detected at the station S3 are presently detected at the attraction 2. The weighted value may further include the percentage 40% of wireless devices previously detected at the station S2 which are presently detected at the attraction 2 as described above. Based on the weighted value of 40% and the difference information of 3 pax at the station S2, and the weighted value of 100% and the difference information of 1 pax at the station S3, the volume of undetected visitors at the attraction 2 may be estimated to be (40%×3 pax)+(100%×1 pax), being about 2-3 pax. Accordingly, the visitor volume at the attraction 2 may be determined, for example, by adding the volume of detected wireless devices (i.e. 2+4=6 pax) and the estimated volume of undetected visitors (2-3 pax).

In another exemplary embodiment, the weighted value may be a volume of wireless devices previously detected at each of the at least one first site and presently detected at the second site. For example, the weighted value may include a value of 2 indicating the 2 wireless devices previously detected at the station S2 and presently detected at the attraction 2, and may include a value of 4 indicating the 4 wireless devices previously detected at the station S3 and presently detected at the attraction 2. The difference information determined at the station S2 may be the ratio between the volume of detected wireless device and the volume of detected visitors, in this example, 5/8. The difference information determined at the station S3 may be the ratio between the volume of detected wireless device and the volume of detected visitors, in this example, 4/5. Accordingly, the visitor volume at the attraction 2 may be estimated based on the weighted value and the difference information, for example,

$$\frac{2}{5 \text{/} 8} + \frac{4}{4 \text{/} 5} .$$

The above embodiments illustrate two different forms of the difference information and the weighted value that may be used to determine the visitor volume. It is understood that the difference information and the weighted value may be determined in various other forms in other embodiments. For example, in accordance with various types of difference information as described with reference to FIG. 1 above, corresponding weighted value may be determined and may be further used to determine the visitor volume.

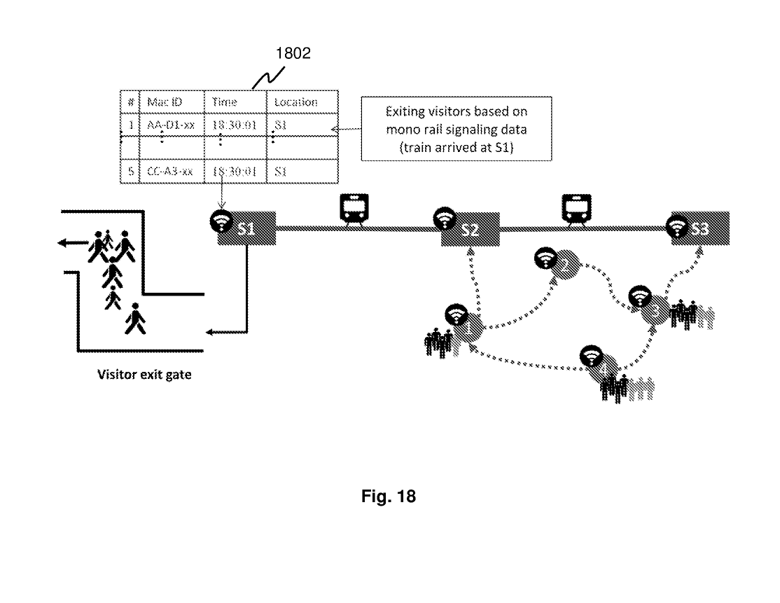

FIG. 18 shows a diagram illustrating data update according to various embodiments. In this exemplary embodiment, visitors exiting the predetermined area 100 may be detected at the exit gate, for example, the train station S1, based on the wireless data 1802 collected at the exit gate. The wireless data 1802 may include identification codes (e.g. MAC-ID) of detected wireless devices at the exit gate. Based on the MAC-IDs from the wireless data 1802, the corresponding visitor distribution table 317 may be updated to remove these corresponding MAC-IDs and the respective weightages 1370 may be updated accordingly.

FIG. 19 illustrates an exemplary system flow of visualizing visitor flow patterns in a predetermined area by a visitor flow pattern visualizer according to various embodiments. The visitor flow pattern visualizer may be the visitor flow patterns visualization module 314 described in FIG. 5 above. The visitor flow patterns visualization module 314 may reside in the system memory 310 of the data processing server 210.

The visitor flow patterns visualization module 314 may be configured to generate a graphic visualization of visitor flow patterns, wherein the visitor flow patterns are determined based on at least one of the determined visitor volume, the visitor distribution table for the wireless devices detected at the at least one first site and the second site, the visitor statistics table including a total volume of visitors within the predetermined area at respective time, or the origin-destination information table including trajectories of visitors. In an exemplary embodiment, the visitor flow patterns visualization module 314 may be configured to conduct comprehensive analysis over the visitor statistics table 315, the OD information table 316 and the visitor distribution table 317 described above.

As illustrated in FIG. 19, a graphic visualization of visitor flow patterns may include a graphic visualization of visitor entry data 1902 determined based on the visitor statistics table 315, and a graphic visualization of visitor exit data 1904 determined based on the visitor statistics table 315. The visitor statistics table 315 may be determined based on at least one of the farecard data or video data at the entrance, and based on the wireless data at the exit according to the embodiments of FIGS. 8 and 9 above. The graphic visualizations 1902, 1094 of visitor entry and exit data may indicate the total numbers of visitor inside the predetermined area 100, e.g., the island resort.

The visitor flow patterns visualization module 314 may be further configured to generate a graphic visualization of the visitor flow patterns at stations 1906, which is the result of aggregation between train arrival timing and visitor volume distribution determined based on the video data and the wireless data according to various embodiments above. For example, the visitor volume for each train at the station S3 is visualized in 1906, including both visitor volume detected by the wireless device detectors and the estimated visitor volume undetected by the wireless device detectors determined according to the methods of FIGS. 16 and 17 above, for example. The train signaling data may be visualized in the graphic visualization 1908, indicating train arrival and departure time of respective trains at respective train stations S1-S3.

The visitor flow patterns visualization module 314 may be further configured to generate a graphic visualization of the visitor flow patterns at different attractions 1910 based on the visitor distribution table 317 and the OD information table 316.

According to various embodiments, the visitor flow patterns visualization module 314 may generate a graphic visualization in terms of transport modes they have taken as well as duration of stays within the island resorts. It may also display respective visitor distributions across different places based on statistical analysis of multiple sensor types. The visualization may simulate an overall picture of visitor flows as well as individual's mobility, and may provide an integrated multi-level analysis approach for visitors' trajectories with advanced reporting tool.

Accordingly, the system and method for visitor flow analysis according to various embodiments above may include the statistical analysis to summarize characteristics of an individual visitor's activities, preferred transport modes, duration of stay for each visited place, and recorded trajectories from an origin to a destination within the island resort. According to individual visitor's mobility, overall visitors' volume and transport modes may be aggregated from microscopic scale to macroscopic scale in order to understand individual and overall pictures of visitor flow patterns within the island resort.

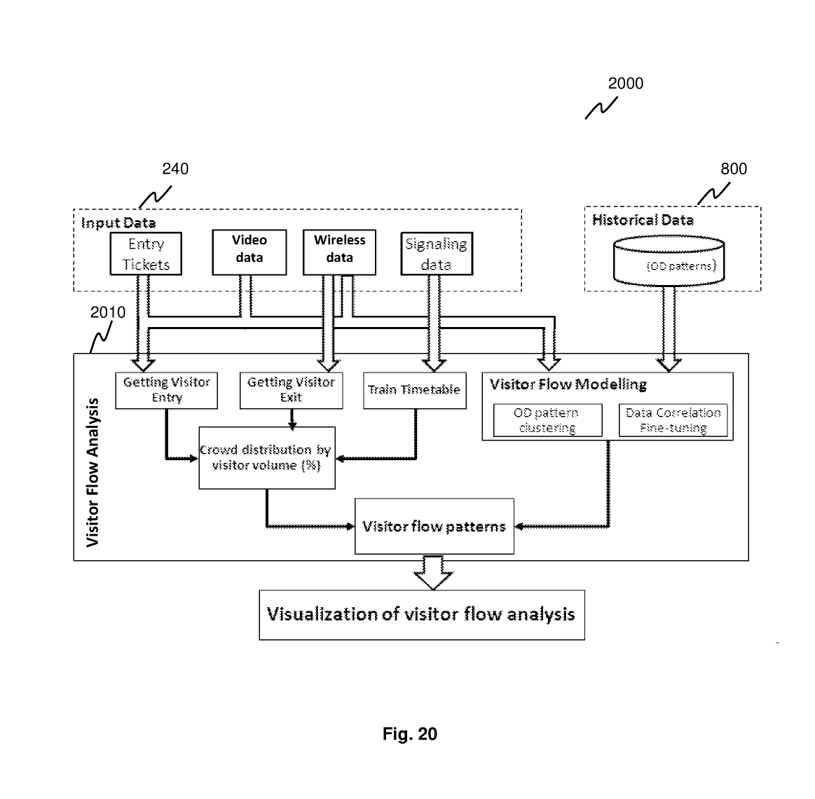

FIG. 20 shows a system overview of a visitor flow analysis system according to various embodiments. The system 2000 receives or retrieves input data 240, such as entry tickets data, video data, wireless data and train signaling data described above, for visitor flow analysis. The system 200 further receives or retrieves historical wireless data 800 described above for determining origin-destination (OD) patterns.

The system 2000 include a visitor flow analysis module 2010 configured to perform analysis based on the input data 240 and the historical wireless data 800. The visitor flow analysis module 2010 may obtain visitor entry data from the entry tickets data, obtain visitor exit data from the wireless data, and may obtain train timetable from the signaling data. Based on the visitor entry data, the visitor exit data, and the train timetable, crowd distribution by visitor volume (%) may be determined, which may indicate percentages of visitor volumes at various locations, for example. The visitor flow analysis module 2010 is further configured to perform visitor flow modeling based on the input data 240 and the historical wireless data 800, including OD pattern clustering and data correlation fine-tuning. The visitor flow analysis module 2010 is further configured to determine the visitor flow patterns based on the determined crowd distribution and the determined visitor flow modeling. The system 2000 may further include a visualization module to visualize the visitor flow patterns.

According to various embodiments above, a system and a method are provided to analyze visitor flow for a predetermined area, e.g. an island resort, which is distant area with complimentary service of multi-modal internal transportation to transfer from one place to another. Various embodiments provide a complete analysis of visitor volume distributions across different sites, based on not only the number of visitors detected within sensor coverage but also the number of visitors who may remain undetected outside of particular sensor coverage within the island resort which is large and separated into distant areas.

Therefore, the system and the method described herein provide an accurate result of individual visitor's mobility as well as overall visitor distributions so as to visualize statistical analysis of visitor flow patterns at the island resort. By understanding characteristics of an individual visitor's transport modes and recorded trajectories, the system and the method of various embodiments may further incorporate with the purpose of optimization for internal multi-modal transport services and resource allocations so as to promote business of island resorts. Accordingly, various embodiments provide a system and a method to analyze visitor flow patterns so as to optimize internal multi-modal transport services and resource allocation to sustain visitor growth.

Existing methods which have been developed for analyzing visitor flow such as the range of video tracking system and mobile device tracking system are limited by ability to detect without sensor full coverage. Some existing methods cannot be applied to detect congested areas or large area. The existing methods do not consider the visitors' volume which may remain undetected. Compared with the existing methods, the system and the method of various embodiments above perform visitor flow analysis including visitors' volume distribution across different sites within the island resort by statistical analysis of data from multiple sensor types, such as train signaling data, wireless data, video data and farecard data. Thus, the system and the method of various embodiments prevent inaccurate result as much as possible by eliminating the limitation of particular sensor types.

The system and the method of various embodiments allow to understand how the visitors transfer from one place to another and also to understand how many of visitors enter and exit the island resort. The system and the method of various embodiments obtain the number of visitors entering the island resort by counting farecard (entry tickets) transactions and by human counting solution of video data (e.g. CCTV footages) that covers the number of visitors who passed through the gate within closed area. Analysis of wireless data may generate visitors' origin and destinations distribution, as wireless network service may be commonly provided at mono-rail stations and key locations within the island resort. In order to correlate with transport modes, analysis of train signaling data may generate mono-rail arrival and departure timetable. Moreover, visitors' volume may be derived from CCTV footages and wireless data so as to verify and analyze the ratio between the number of visitors detected by wireless network service and the number of visitors who may remain undetected beyond wireless network service at a given time. Computation of visitor distribution ratio may be achieved accurately within a closed area, such as mono-rail stations, as cameras (e.g. CCTV) can cover the closed area to count the number of visitors who alighted at the stations.

The determined visitor distribution ratio may be further applied for visitor flow analysis across the island resort when visitors transfer from one site to another using alternative transport modes. In addition, the system may also determine transport modes which visitors may have taken to transfer. When visitors exit the island resort, the ratio may then be revised based on the identification codes (e.g. MAC-ID) of wireless devices detected at the exit. Through these various embodiments, the system and the method extract data correlation from different sensors, such as video data, wireless data and mono-rail signaling data.

Hence, various embodiments provide a system and a method for visitor flow patterns analysis by determining characteristics of an individual visitor's activities, preferred transport modes, duration of stay for each visited place, and recorded trajectories from start to end within the island resort. In particular, various embodiments described herein provide an accurate result of individual visitor's mobility as well as overall visitor distributions so as to visualize statistical analysis of visitor flow patterns at the island resort by correlating and analyzing multiple sensor data.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

1. A system for visitor flow analysis at a plurality of sites within a predetermined area, the system comprising:
a difference estimator configured to determine a difference information between video data of visitors at at least one first site of the plurality of sites and wireless data of detected wireless devices carried by the visitors at the at least one first site; and
a visitor volume distribution estimator configured to determine a visitor volume at a second site of the plurality of sites, based on wireless data of detected wireless devices at the second site and the difference information at the at least one first site.

2. The system of claim 1, wherein the difference information at the at least one first site comprises at least one of:
a volume of undetected wireless devices at the at least one first site, representing a difference between a volume of detected visitors and a volume of detected wireless devices at the at least one first site;
a ratio between the volume of undetected wireless devices and the volume of detected wireless devices at the at least one first site;
a ratio between the volume of undetected wireless devices and the volume of detected visitors at the at least one first site; or
a ratio between the volume of detected wireless devices and the volume of detected visitors at the at least one first site.

3. The system of claim 1, wherein the wireless data of detected wireless devices at the at least one first site or at the second site comprises at least one of:
an identification code of each detected wireless device, or
a previous site where each wireless device is detected, wherein the previous site is associated with the identification code of the respective wireless device.

4. The system of claim 1, wherein the visitor volume distribution estimator is further configured to determine a weighted value of detected wireless devices at the second site based on the wireless data of detected wireless devices at the second site;
wherein the weighted value of detected wireless devices at the second site comprises at least one of:
a volume of wireless devices previously detected at each of the at least one first site and presently detected at the second site, or
a percentage of wireless devices previously detected at each of the at least one first site which are presently detected at the second site.

5. The system of claim 4, wherein the visitor volume distribution estimator is configured to determine the visitor volume at the second site based on the weighted value of detected wireless devices at the second site and the difference information at the at least one first site.

6. The system of claim 1, wherein the visitor volume distribution estimator is further configured to determine a visitor volume at the at least one first site based on the video data of visitors at the at least one first site.

7. The system of claim 1, wherein the visitor volume distribution estimator is further configured to generate a visitor distribution table for the wireless devices detected at the at least one first site and the second site, the visitor distribution table including at least one of:
previous sites and current sites where the wireless devices are detected, wherein the previous sites and the current sites are associated with respective identification codes of the respective wireless devices; or
the difference information at the at least one first site where the wireless devices are detected, wherein the difference information is associated with the respective identification codes of the respective wireless devices.

8. The system of claim 1, further comprising:
a camera at each of the at least one first site, configured to provide the video data of visitors at each of the at least one first site; and
a wireless device detector at each of the at least one first site and at the second site, configured to provide the wireless data of detected wireless devices at each of the at least one first site and the wireless data of detected wireless devices at the second site, respectively.

9. The system of claim 1,
wherein the at least one first site comprises a train station,
wherein the difference estimator is configured to determine a train arrival time based on train signalling data, and configured to determine the difference information corresponding to the train arrival time.

10. The system of claim 1, further comprising a visitor statistics register configured to:
determine a volume of visitors entering the predetermined area based on at least one of video data or entry ticket data at an entrance of the predetermined area, and
determine a volume of visitors exiting the predetermined area based on wireless data of detected wireless devices at an exit of the predetermined area.

11. The system of claim 10, wherein the visitor statistics register is further configured to generate a visitor statistics table comprising a total volume of visitors within the predetermined area at respective time.

12. The system of claim 1, further comprising a visitor origin-destination mapper configured to determine a trajectory of each visitor based on historical wireless data of wireless devices detected at the at least one first site and the second site.

13. The system of claim 12, wherein the visitor origin-destination mapper is further configured to generate an origin-destination information table, the origin-destination information table comprising the trajectory of the respective visitor including an identification code of the respective wireless device carried by the respective visitor, an origin of the respective visitor, and a destination of the respective visitor.

14. The system of claim 1, further comprising a visitor flow pattern visualizer configured to generate a graphic visualization of visitor flow patterns,
wherein the visitor flow patterns are determined based on at least one of the determined visitor volume, a visitor distribution table for the wireless devices detected at the at least one first site and the second site, a visitor statistics table comprising a total volume of visitors within the predetermined area at respective time, or an origin-destination information table comprising trajectories of visitors.

15. A method for visitor flow analysis at a plurality of sites within a predetermined area, the method comprising:
determining a difference information between video data of visitors at at least one first site of the plurality of sites and wireless data of detected wireless devices carried by the visitors at the at least one first site; and
determining a visitor volume at a second site of the plurality of sites, based on wireless data of detected wireless devices at the second site and the difference information at the at least one first site.
